(19) United States
(12) Patent Application Publication
(10) Pub. No.: US 2025/0139046 A1
(43) Pub. Date: May 1, 2025

(54) DUAL PROTOCOL COMMUNICATION WITH POOL AUTOMATION CONTROLLER

(71) Applicant: Zodiac Pool Systems LLC, Carlsbad, CA (US)

(72) Inventors: Minas Minassian, Carlsbad, CA (US); Jay Wherley, Carlsbad, CA (US); Sandra Morrison, Carlsbad, CA (US)

(73) Assignee: Zodiac Pool Systems LLC, Carlsbad, CA (US)

(21) Appl. No.: 18/929,230

(22) Filed: Oct. 28, 2024

Related U.S. Application Data
(60) Provisional application No. 63/546,664, filed on Oct. 31, 2023.

(51) Int. Cl. G06F 13/42

(52) U.S. Cl. CPC G06F 13/42; G06F 2213/40

(57) ABSTRACT

Systems and methods of implementing multiple communication protocols for equipment of a pool or spa system using a bus are described herein. The systems and methods are further configured to coordinate messaging with the equipment using the multiple communication protocols. In an example, a system determines that a first device of equipment of the pool or spa system is associated with a first communication protocol. The system communicates with the first device via the first communication protocol. The system determines that a second device of the equipment of the pool or spa system is associated with a second communication protocol. The system communicates with the second device via the second communication protocol.

### CROSS REFERENCE TO RELATED APPLICATION(S)

This application claims the benefit of U.S. Provisional Patent Application No. 63/546,664, filed on Oct. 31, 2023, and entitled DUAL PROTOCOL COMMUNICATION WITH POOL AUTOMATION CONTROLLER, the content of which is hereby incorporated by reference in its entirety.

### FIELD

The present disclosure relates generally to pool automation systems and more particularly, although not exclusively, to dual protocol communication for pool equipment.

### BACKGROUND

Pool and spa systems may include a variety of equipment, such as pumps, vacuum ports, chlorinators, skimmers, heaters, filters, etc. Equipment may be controlled by a pool automation controller by various means, such as relays or digital signals. However, equipment may communicate via various communication protocols.

### BRIEF SUMMARY

Various examples are described including systems, methods, and devices relating to dual protocol communication of pool or spa equipment. One embodiment can involve a pool or spa system configured for dual protocol communication of pool or spa equipment. The system can include a plurality of devices of equipment. The plurality of devices of the equipment including a first device and a second device. The system also includes a bus configured to communicate with a pool automation controller, the first device, and the second device. The system includes the pool automation controller that includes a memory configured to store computer-executable instructions; and one or more processors configured to access the memory and execute the computer-executable instructions to at least: determine that the first device is associated with a first communication protocol; communicate, using the bus, with the first device via the first communication protocol; determine that the second device is associated with a second communication protocol; and communicate, using the bus, with the second device via the second communication protocol.

Another embodiment can include a computer-implemented method for dual protocol communication of pool or spa equipment of a pool or spa system. The method can involve determining that a first device of equipment of the pool or spa system is associated with a first communication protocol and communicating with the first device via the first communication protocol. The method can also involve determining that a second device of the equipment of the pool or spa system is associated with a second communication protocol and communicating with the second device via the second communication protocol.

Another embodiment can include pool automation controller for a pool or spa system configured for dual protocol communication of pool or spa equipment. The pool automation controller can include a memory configured to store computer-executable instructions; and one or more processors configured to access the memory and execute the computer-executable instructions to at least: determine that a first device of the plurality devices is associated with a first communication protocol; communicate, using a bus configured to communicate with the plurality of devices of the pool or spa equipment, with the first device via the first communication protocol; determine that the second device of the plurality of devices is associated with a second communication protocol; and communicate, using the bus, with the second device via the second communication protocol.

### BRIEF DESCRIPTION OF THE DRAWINGS

FIG. 1 illustrates a pool system controlled by a pool automation controller, according to at least one example.

FIG. 2 illustrates a pool system for dual protocol communication in a pool or spa system, according to at least one example.

FIG. 3 illustrates a flow chart depicting an example process for managing dual protocol communication of equipment in a pool or spa system, according to at least one example.

FIG. 4 illustrates a flow chart depicting an example process for dual protocol communication in a pool or spa system by a bus included in a pool automation controller, according to at least one example.

FIG. 5 illustrates examples of a computer system for dual protocol communication, according to at least one example.

### DETAILED DESCRIPTION

Examples described herein relate to systems, devices, and techniques for dual protocol communication for pool equipment. A pool automation controller may be configured to communicate with devices of pool or spa equipment to monitor or control the devices. The pool automation controller can communicate with the devices over a single wire or network. Devices may be configured to communicate using various communication protocols. For instance, some devices can use an Internet Protocol (IP)-based communication protocol, whereas other devices can use a non-IP-based communication protocol (e.g., Recommended Standard (RS)-485 serial communications, RS-422, controller area network (CAN) bus protocol, etc.). To ensure that the pool automation controller is able to communicate with each device, the pool automation controller can communicate with each device using their respective communication protocol. To do so, the pool automation controller can determine a communication protocol for each device of the pool equipment and then communicate with each device in its respective communication protocol. For example, the pool automation controller and the devices can be communicatively coupled to a bus that can communicate in both the IP-based communication protocol and the non-IP-based communication protocol so that all of the devices may be accurately and efficiently monitored and controlled. In this way, the pool automation controller may use a serial network and communicate with the end device using the correct communication protocols.

In a particular example, the pool automation controller can communicate with a circulation pump and a chlorinator. The circulation pump can communicate using a non-IP-based communication protocol. For instance, the circulation pump can use 9600 bps RS-485 serial communications (e.g., RS-485 protocol). In contrast, the chlorinator can communicate using an IP-based communication protocol, such as serial line Internet Protocol (SLIP). The pool automation controller includes a bus that is capable of sending and receiving communications in both protocols. The pool automation controller also includes the appropriate software and control modules to enable the functions of communicating over multiple protocols. In some instances, a device may transmit a communication in response to receiving a message from the pool automation controller. The message from the pool automation controller can be a command for configuring settings of the device, collecting data from the device, detecting a presence of the device, etc. The message can be of any suitable type such as a message queuing telemetry transport (MQTT) message, a RabbitMQ message, a Kafka message, and the like.

As a non-limiting example, the bus can send a message associated with an IP address of the chlorinator using SLIP. Since the message is associated with the IP address of the chlorinator, any other device that uses SLIP communication can be disabled since the IP address is different from the associated IP address of the chlorinator. The chlorinator detects the message and can respond to the bus within a predefined time (e.g., 250 ms) using SLIP. Subsequently, the bus can send a message directed to the circulation pump using the RS-485 protocol. The circulation pump detects the message and can respond to the bus using the RS-485 protocol. As such, the pool automation controller communicates with each device individually using its corresponding communication protocol. In addition, the communication with each device can be coordinated so that messages from multiple devices and of different protocols are not mixed or missed by the pool automation controller.

In the interest of clarity, not all of the routine features of the examples described herein are shown and described. It will of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

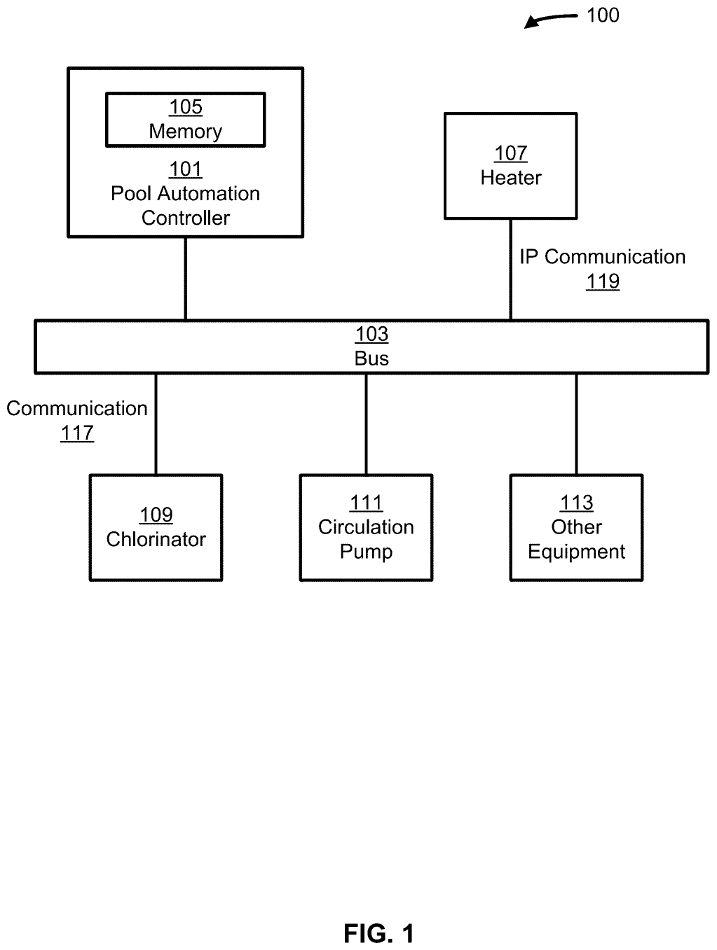

Turning now to the figures, FIG. 1 illustrates a pool system 100 controlled by a pool automation controller 101, according to at least one example. The pool automation controller 101 is communicatively coupled to a bus 103 for communicating with various pool equipment via one or more communication protocols. For example, the pool automation controller 101 can use the bus 103 to communicate with a heater 107, a chlorinator 109, a circulation pump 111, and other equipment 113 of the pool system 100 that are also communicatively coupled to the bus 103. The bus 103 may be a serial bus that transmits data over a single wire. The topology of the pool system 100 may be based on a standard that defines the electrical characteristics of drivers and receivers for use in serial communications. For instance, the pool system 100 may be based on RS-485, but the pool automation controller 101 can use the bus 103 to communicate via RS-485 and IP over that network. The pool automation controller 101 can detect a communication protocol used when a device of the pool equipment sends a message to the pool automation controller 101 and provide subsequent communications to the device using the detected communication protocol. For instance, some devices can use an IP-based communication protocol, and other devices can use a non-IP-based communication protocol.

Devices that communicate using a non-IP communication protocol may operate at a baud rate of 9600 bits per second (bps) and without encrypted messages. In contrast, devices that communicate using an IP communication protocol may operate at a highest feasible baud rate that a particular system allows and can provide encrypted communication (e.g., by transport layer security (TLS) encryption). The number of devices, termination, cable length, and other characteristics may reduce the baud rate capabilities of the system. The IP communication protocol may allow for reduced speed operation, with devices adapting to the changing baud rate. A default baud rate for devices that use the IP communication protocol may be 115200 bps. Other exemplary baud rates include 230400 bps, 460800 bps, 921600 bps, and 1500000 bps.

A device that uses the non-IP-based communication protocol can have a byte address of a predetermined length (e.g., one byte), and a device that uses the IP communication protocol can be identified by a unique IP address that is selected by the device. A device that uses the IP communication protocol can randomly select an IP address in a predefined range (e.g., 169.254.1.5-169.254.254.254). Periodically (e.g., at least once per minute), the pool automation controller 101 can send out a blast message announcing the IP network configuration. For instance, the blast message can include IP addresses of known devices in the pool system 100 and respective checksums for cyclic redundancy checks. As such, this message can contain the network configuration and a list of already assigned device IP addresses. The blast message can also contain an indication of the operational baud rate for response messaging (e.g., message queuing telemetry transport (MQTT) messaging). This blast message can be sent at each of the baud rates such that devices operating at any of the baud rates can receive it.

Devices can use the blast message to learn if their self-selected IP address has been recognized. Until the device receives the blast message containing its information and IP address, it can periodically transmit a broadcast SLIP message announcing its self-selected IP address. This message can be received and processed by the pool automation controller 101 to build its list of connected devices and corresponding IP addresses. That is, upon the pool automation controller 101 receiving the broadcast SLIP message, the pool automation controller 101 determines the device and its IP address and stores an association between the device and the IP address in the list of connected devices and corresponding IP addresses. In addition, since the IP address was received as the broadcast SLIP message, the pool automation controller 101 can determine that the communication protocol for communicating with the device is SLIP. Once the device detects its matching unit code and cyclic redundancy check (CRC) in the blast message, it can determine that its IP address has been recognized. The device can then use the corresponding IP address to bring up its SLIP interface for communications using SLIP packets.

The pool automation controller 101 also includes a memory 105 for storing addresses and communication protocol indications for each device of the pool equipment. For instance, the memory 105 can store a first association between an address of the chlorinator 109 and its communication protocol (e.g., a non-IP communication protocol) and a second association between an IP address of the heater 107 and its communication protocol (e.g., an IP communication protocol). After detecting the devices and storing their respective communication protocols and addresses, the pool automation controller 101 can use the bus 103 to communicate with and control the devices via the appropriate communication protocols. As an example, the pool automation controller 101 can send a message intended for a heater 107 of the pool equipment. Since the heater 107 can use an IP communication protocol, such as the SLIP protocol, the bus 103 can provide the message as an IP communication 119 to the heater 107 in the SLIP protocol. In addition, the heater 107 can provide a response to the message using the SLIP protocol.

The pool automation controller 101 can send out an additional message intended for a chlorinator 109 of the pool equipment. Since the chlorinator 109 can use a non-IP communication protocol, such as the RS-485 protocol, the bus 103 can provide the message as a non-IP communication 117 to the chlorinator 109 in the RS-485 protocol. In addition, the chlorinator 109 can provide a response to the message using the RS-485 protocol.

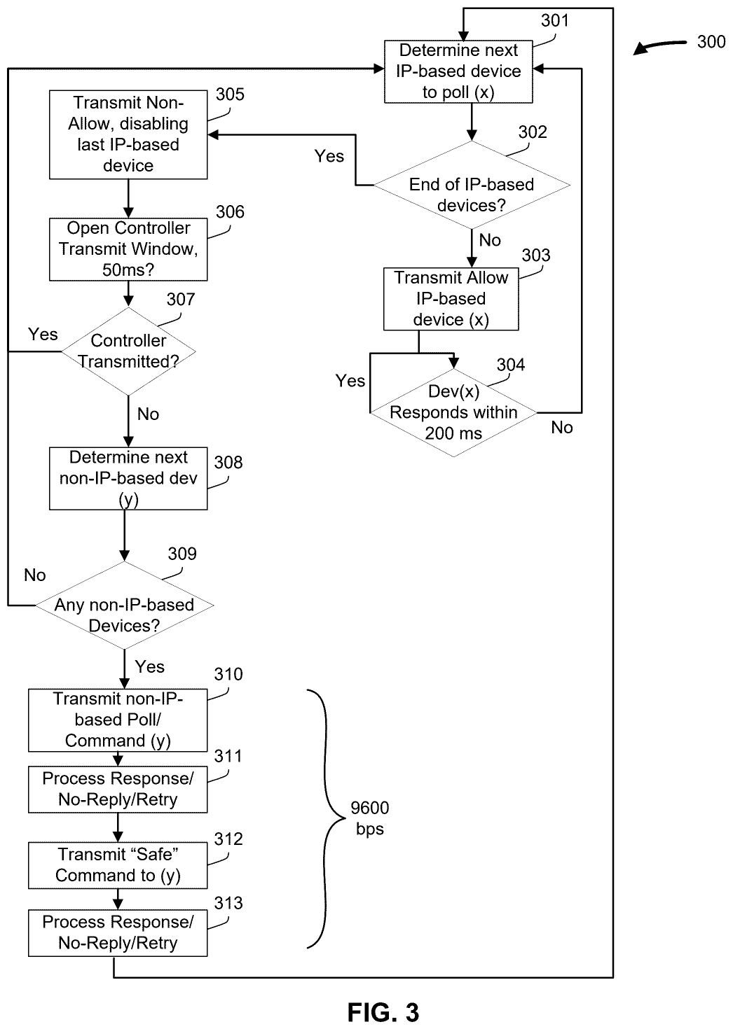

Because the topology of the network, which may be an RS-485 network, is multi-point two wire, the system may need to ensure only one device transmits a message at a time. In general, the pool automation controller 101 can initiate messages and direct the flow control of the devices. In addition, the IP-based communication protocol devices can implement rules to reduce the likelihood of multiple messages being transmitted simultaneously. For instance, the rules can involve an IP-based communication protocol device being able to transmit SLIP message(s) only when it has seen a SLIP message directed to its address from the pool automation controller 101. Additionally, if an IP-based communication protocol device sees a SLIP message directed to any device other than itself, it can engage flow control to hold off transmission of messages until after it next sees a message directed to its address. Furthermore, an IP-based communication protocol device can only transmit one SLIP packet when allowed to transmit and require reception of further directed messages to transmit again. Additional details about the messaging flow for the pool automation controller 101 and the pool equipment devices are provided in FIG. 3.

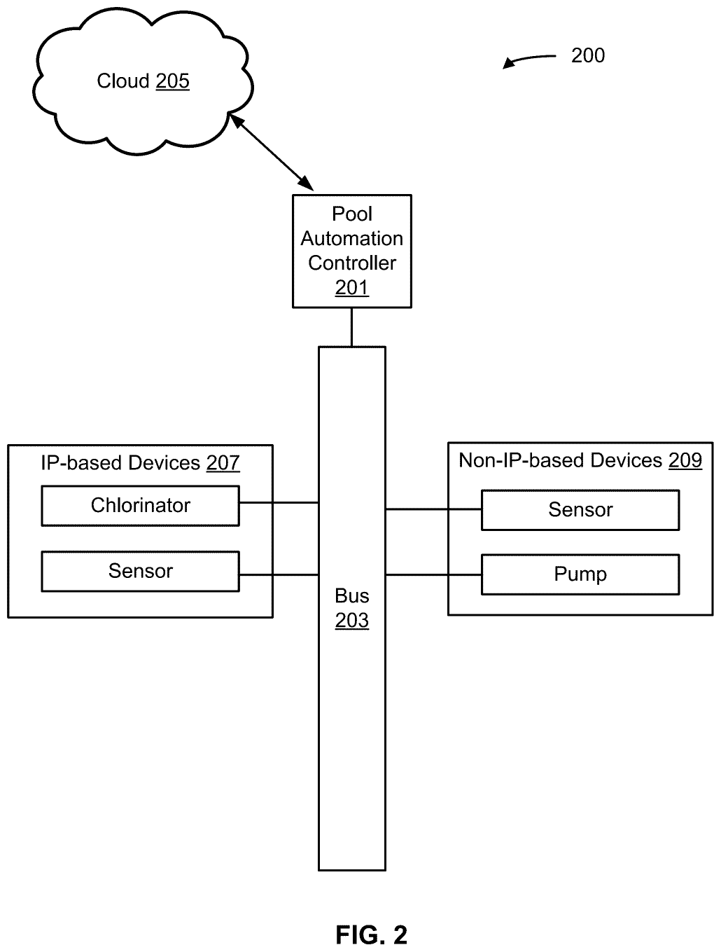

FIG. 2 illustrates a pool system 200 for dual protocol communication in a pool or spa system, according to at least one example. The pool system 200 includes a pool automation controller 201, which can be referred to as a core node. The pool automation controller 201 is connected to a cloud 205 and a bus 203 for communication with IP-based devices 207 and non-IP-based devices 209. The IP-based devices 207 can be referred to as contemporary devices and can correspond to devices that communicate using IP-based communication protocols, whereas non-IP-based devices 209 can be referred to as legacy devices that use 9600 bps RS-485 protocol communications. The IP-based communications can be encrypted and provide certificate authentication from the IP-based devices 207. Non-limiting examples of the IP-based devices 207 include a chlorinator, a sensor, or other device. Non-limiting examples of the non-IP-based devices 209 include a sensor, a pump, or other device. Both the IP-based devices 207 and the non-IP-based devices 209 can be other devices besides those specifically listed.

For the IP-based devices 207, the pool automation controller 201 is accessible over Wi-Fi or IP-based communication (e.g., SLIP). As a non-limiting example, the IP-based devices 207 can each use an IP address between 169.254.1.5 and 169.254.254. Each of the IP-based devices 207 can establish an MQTT connection to the pool automation controller 201 and subscribe and publish to topics on the pool automation controller 201. An MQTT bridge on the pool automation controller 201 can map topics to and from the cloud 205, IP-based devices 207, and non-IP-based devices 209. In addition, the IP-based devices 207 can agnostically connect to the pool automation controller 201 over Wi-Fi and perform MQTT messaging that way.

The pool automation controller 201 includes polling logic that continuously allows only a single IP-based device to transmit a message at a time. This can be done with a custom user datagram protocol (UDP) broadcast over SLIP. The SLIP interface can use a 169.254.1.1 IP address in one example. In addition, the polling logic alternates between messaging with the IP-based devices 207 and the non-IP-based devices 209 to manage the communications by both types of devices. The pool automation controller 201 can use 9600 bps messaging for the non-IP-based devices 209. To alternate the messaging, the pool automation controller 201 may send messages to each of the IP-based devices 207 individually before sending a message to a non-IP-based device. Then, the pool automation controller 201 can send messages to each of the non-IP-based devices 209 before returning to communicating with the IP-based devices 207. In this way, the pool automation controller 201 performs round robin messaging with the IP-based devices 207 and the non-IP-based devices 209. The flow of the messaging is shown in FIG. 3.

FIG. 3 illustrates a flow chart depicting an example process 300 for managing dual protocol communication of equipment in a pool or spa system, according to at least one example. A pool automation controller (e.g., pool automation controller 201 in FIG. 2) of the pool or spa system can perform the process 300 each time it tries to communicate with connected devices. The steps of FIG. 3 are described with respect to the components of FIG. 2.

The process 300 begins at step 301 by the pool automation controller 201 determining whether there is an IP-based device to poll. Polling can involve sending a message to the IP-based device and receiving a response to the message from the IP-based device. The message and response may be related to a monitoring operation or a control operation for the IP-based device. If the pool automation controller 201 determines at step 302 that there are not any more IP-based devices 207, the pool automation controller 201 proceeds to step 305. The pool automation controller 201 may look up a table that identifies each of the IP-based devices 207 so that the pool automation controller 201 can determine when each of the IP-based devices 207 has been polled. As another example, the pool automation controller 201 may receive a user input indicating the IP-based devices 207 or may check a status of a port of the pool automation controller 201 or of a bus connecting the pool automation controller 201 to the IP-based devices 207 and non-IP-based devices 209 to determine when each of the IP-based devices 207 has been polled.

If there is a next IP-based device to poll, the pool automation controller 201 transmits an allowance message to the next IP-based device at step 303, which disables all other IP-based devices of the pool system 200. The allowance message may include an IP address of the IP-based device. The other IP-based devices may receive the allowance message, and upon detecting a non-matching IP address to their own, the other contemporary devices may ignore and prevent further processing of the allowance message. The pool automation controller 201 sends the allowance message using a communication protocol associated with the IP-based device. The pool automation controller 201 may store an association between the IP-based device and its communication protocol or the pool automation controller 201 may determine the communication protocol of the IP-based device based on a message received from the IP-based device.

The pool automation controller 201 then determines whether a response is received from the IP-based device within a period of time (e.g., 200 ms) at step 204. The response is received from the IP-based device using the communication protocol of the IP-based device. If so, the pool automation controller 201 continues communicating with the IP-based device by sending one or more additional messages to the IP-based device using its communication protocol. Otherwise, the pool automation controller 201 returns to determining whether there is another IP-based device to poll at step 301. Once each IP-based device has been polled, the pool automation controller 201 transmits a non-allowance message to the most recent IP-based device at step 305, which disables the IP-based device. As a result, the IP-based device can no longer send messages to the pool automation controller 201 until receiving another allowance message from the pool automation controller 201.

Then, the pool automation controller 201 opens a time window for transmitting messages to the IP-based devices 207 at step 306. For instance, the time window can be 50 ms based on the baud rate of 115200 bps. If a message is sent to an IP-based device during the time window at step 307, the pool automation controller 201 can return to step 301 of determining an IP-based device to poll based on the message. When no messages are available to send at step 307 and the pool automation controller 201 determines there is a non-IP-based device at steps 308 and 309 (e.g., based on a lookup of a table, a user input, a port status, etc.), the pool automation controller 201 transmits a non-IP-based poll/command to the non-IP-based device at step 310, processes a response (which may be a no reply or a retry message) at step 311, and transmits a “safe” command to the non-IP-based device at step 312. The “safe” command may securely send a command to the non-IP-based device. At step 313, the pool automation controller 201 processes another response from the non-IP-based device. After completing the messaging with the non-IP-based device at step 313, or if there are no non-IP-based devices to poll at step 309, the pool automation controller 201 returns to step 301 of determining an IP-based device to poll. So, in general, the pool automation controller 201 ensures that communication occurs with one device at a time so that various communication protocols can be used and to prevent receiving simultaneous messages from multiple devices.

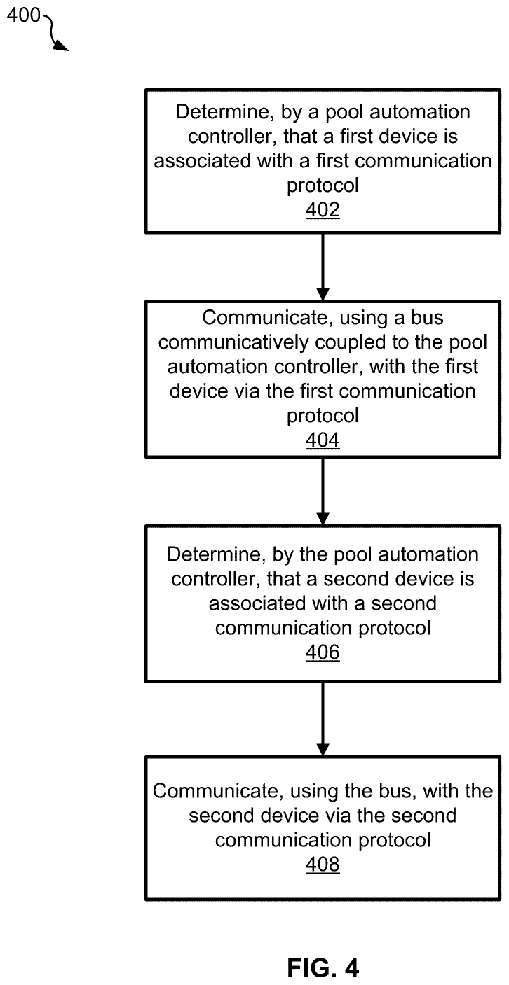

FIG. 4 illustrates an example flow diagram showing a process 400, according to at least one example. This process, and any other processes described herein, is illustrated as a logical flow diagram, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the process.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

FIG. 4 illustrates a flow chart depicting an example process 400 for dual protocol communication in a pool or spa system by a bus included in a pool automation controller. The process 400 is performed by a pool automation controller (e.g., the pool automation controller 101 of FIG. 1).

The process 400 begins at block 402 by the pool automation controller 101 determining that a first device is associated with a first communication protocol. The pool automation controller 101 is part of a pool or spa system that is configured for dual protocol communication with pool or spa equipment. The system also includes a plurality of devices of equipment. The plurality of devices of the equipment includes the first device and a second device. The system also includes a bus 103 configured to communicate with the pool automation controller 101, the first device, and the second device. The first communication protocol can be an IP-based communication protocol and determining that the first device is associated with the first communication protocol can involve receiving, from the first device, a broadcast message indicating an IP address of the first device and determining, based on the broadcast message, that the first device is associated with the IP-based communication protocol. The pool automation controller 101 stores a first association between the first device and the first communication protocol. The first association indicates the IP address of the first device. The first device can be a heater 107 that uses an IP communication 119 that is the IP-based communication protocol. For instance, the IP communication 119 can be in SLIP protocol. The pool automation controller 101 can receive a message from the heater 107 indicating an IP address of the heater 107. Based on the message, the pool automation controller 101 can determine the first communication protocol used by the heater 107 and store the address along with the first communication protocol. So, when the pool automation controller 101 seeks to communicate with the heater 107, the pool automation controller 101 can look up the stored address and first communication protocol for the heater 107.

The process 400 continues at block 404 by the pool automation controller 101 communicating, using the bus 103 that is communicatively coupled to the pool automation controller 101, with the first device via the first communication protocol. Communicating with the first device via the first communication protocol can involve sending, using the bus 103, a first message to the first device using the IP-based communication protocol and receiving, using the bus 103 and from the first device, a first response to the first message using the IP-based communication protocol. For example, the pool automation controller 101 can use the bus 103 to send a message to the heater 107 using SLIP protocol based on determining that the heater 107 uses the SLIP protocol either from the message received from the heater 107 or from the stored information about the heater 107.

The process 400 continues at block 406 by the pool automation controller 101 determining that a second device is associated with a second communication protocol. At least one of the first communication protocol or the second communication protocol can be an IP-based communication protocol. In addition, at least one of the first communication protocol or the second communication protocol can be a non-IP-based communication protocol. The second communication protocol can be the non-IP-based communication protocol and determining that the second device is associated with the second communication protocol can involve receiving, from the second device, a message indicating an address of the second device and determining, based on the message, that the second device is associated with the non-IP-based communication protocol. The pool automation controller 101 stores a second association between the second device and the second communication protocol. The second association indicates the address of the second device. The second device can be a chlorinator 109 that uses a communication 117 that is a non-IP-based communication protocol. For instance, the non-IP communication 117 can be in RS-485 protocol. The pool automation controller 101 can receive a message from the chlorinator 109 indicating an address of the chlorinator 109. Based on the message, the pool automation controller 101 can determine the second communication protocol used by the chlorinator 109 and store the address along with the second communication protocol. So, when the pool automation controller 101 seeks to communicate with the chlorinator 109, the pool automation controller 101 can look up the stored address and second communication protocol for the chlorinator 109.

The process 400 continues at block 408 by the pool automation controller 101 communicating, using the bus 103, with the second device via the second communication protocol. Communicating with the second device via the second communication protocol can involve sending, using the bus 103, a second message to the second device using the non-IP-based communication protocol and receiving, using the bus 103 and from the second device, a second response to the second message using the non-IP-based communication protocol. The pool automation controller 101 can use the bus 103 to send a message to the chlorinator 109 using RS-485 protocol based on determining that the chlorinator 109 uses RS-485 protocol either from the message received from the chlorinator 109 or from the stored information about the chlorinator 109. The pool automation controller 101 can also coordinate communication with the first device using the IP-based communication protocol and the second device using the non-IP-based communication protocol to prevent receiving simultaneous messages from the first device and the second device.

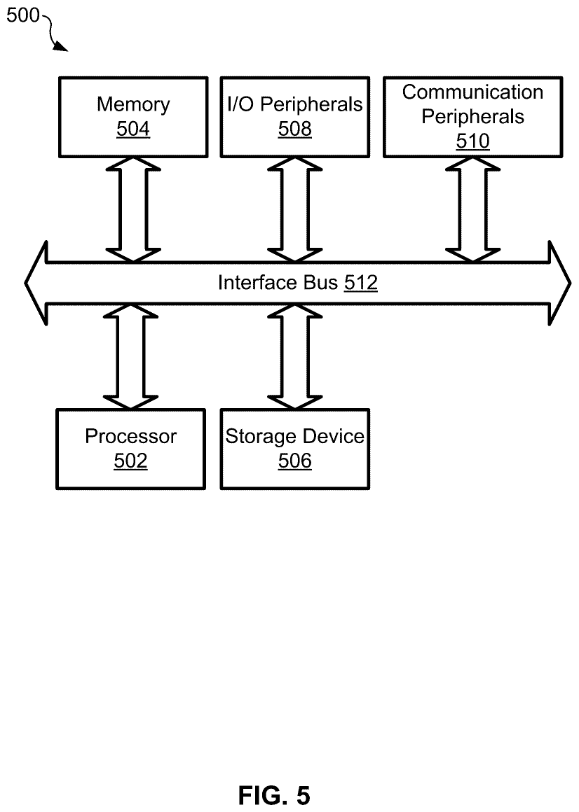

FIG. 5 illustrates examples of a computer system 500 for dual protocol communication, according to at least one example. The computer system 500 can be a single computer such as a user computing device and/or can represent a distributed computing system such as one or more server computing devices. The computer system 500 is an example of the external computing devices, processing circuitry, controllers and/or microcontrollers of pool equipment and/or the pool automation controller 101, and the like.

The computer system 500 may include at least a processor 502, a memory 504, a storage device 506, input/output peripherals (I/O) 508, communication peripherals 510, and an interface bus 512. The interface bus 512 is configured to communicate, transmit, and transfer data, controls, and commands among the various components of the computer system 500. The memory 503 and the storage device 506 include computer-readable storage media, such as Random Access Memory (RAM), Read ROM, electrically erasable programmable read-only memory (EEPROM), hard drives, CD-ROMs, optical storage devices, magnetic storage devices, electronic non-volatile computer storage, for example Flash® memory, and other tangible storage media. Any of such computer-readable storage media can be configured to store instructions or program code embodying aspects of the disclosure. The memory 504 and the storage device 506 also include computer-readable signal media. A computer-readable signal medium includes a propagated data signal with computer-readable program code embodied therein. Such a propagated signal can take any of a variety of forms including, but not limited to, electromagnetic, optical, or any combination thereof. A computer-readable signal medium includes any computer-readable medium that is not a computer-readable storage medium and that can communicate, propagate, or transport a program for use in connection with the computer system 500.

Further, the memory 504 may include an operating system, programs, and applications. The processor 502 is configured to execute the stored instructions and includes, for example, a logical processing unit, a microprocessor, a digital signal processor, and other processors. The memory 504 and/or the processor 502 can be virtualized and can be hosted within another computing system of, for example, a cloud network or a data center. The I/O peripherals 508 may include user interfaces, such as a keyboard, screen (e.g., a touch screen), microphone, speaker, other input/output devices, and computing components, such as graphical processing units, serial ports, parallel ports, universal serial buses, and other input/output peripherals. The I/O peripherals 508 are connected to the processor 502 through any of the ports coupled to the interface bus 512. The communication peripherals 510 are configured to facilitate communication between the computer system 500 and other computing devices over a communications network and include, for example, a network inference controller, modem, wireless and wired interface cards, antenna, and other communication peripherals.

While aspects of the disclosure are described with respect to pool equipment devices communicating with a pool automation controller in two communication protocols via a bus, other examples can involve additional communication protocols. For instance, the bus of the pool automation controller may support three or more communication protocols. Each of the protocols may be IP-based, non-IP-based, or a combination thereof. As an example, the bus may communicate with a first device in a first non-IP-based communication protocol and with a second device in a second non-IP-based communication protocol.

A collection of exemplary embodiments is provided below, including at least some explicitly enumerated as “Examples” providing additional description of a variety of example embodiments in accordance with the concepts described herein. These examples are not meant to be mutually exclusive, exhaustive, or restrictive; and the disclosure is not limited to these examples but rather encompasses all possible modifications and variations within the scope of the issued claims and their equivalents.

Example 1 is a pool or spa system configured for dual protocol communication of pool or spa equipment, the system comprising: a plurality of devices of equipment, the plurality of devices of the equipment including a first device and a second device; a bus configured to communicate with a pool automation controller, the first device, and the second device; and the pool automation controller comprising: a memory configured to store computer-executable instructions; and one or more processors configured to access the memory and execute the computer-executable instructions to at least: determine that the first device is associated with a first communication protocol; communicate, using the bus, with the first device via the first communication protocol; determine that the second device is associated with a second communication protocol; and communicate, using the bus, with the second device via the second communication protocol.

Example 2 is the system of any preceding or subsequent examples or combination of examples, wherein at least one of the first communication protocol or the second communication protocol comprises an Internet Protocol-based communication protocol.

Example 3 is the system of any preceding or subsequent examples or combination of examples, wherein at least one of the first communication protocol or the second communication protocol comprises a non-Internet Protocol-based communication protocol.

Example 4 is the system of any preceding or subsequent examples or combination of examples, wherein the first communication protocol comprises an Internet Protocol-based communication protocol, and wherein determining that the first device is associated with a first communication protocol comprises: receiving, from the first device, a broadcast message indicating an Internet Protocol address of the first device; and determining, based on the broadcast message, that the first device is associated with the Internet Protocol-based communication protocol.

Example 5 is the system of any preceding or subsequent examples or combination of examples, wherein the second communication protocol comprises a non-Internet Protocol-based communication protocol, and wherein determining that the second device is associated with a second communication protocol comprises: receiving, from the second device, a message indicating an address of the second device; and determining, based on the message, that the second device is associated with the non-Internet Protocol-based communication protocol.

Example 6 is the system of any preceding or subsequent examples or combination of examples, wherein the first communication protocol comprises an Internet Protocol-based communication protocol and the second communication protocol comprises a non-Internet Protocol-based communication protocol, and wherein communicating, using a bus, with the first device via the first communication protocol and with the second device via the second communication protocol comprises: sending, using the bus, a first message to the first device using the Internet Protocol-based communication protocol; receiving, using the bus and from the first device, a first response to the first message using the Internet Protocol-based communication protocol; sending, using the bus, a second message to the second device using the non-Internet Protocol-based communication protocol; and receiving, using the bus and from the second device, a second response to the second message using the non-Internet Protocol-based communication protocol.

Example 7 is the system of any preceding or subsequent examples or combination of examples, wherein the one or more processors are configured to access the memory and execute the computer-executable instructions to further at least: store a first association between the first device and the first communication protocol; and store a second association between the second device and the second communication protocol.

Example 8 is the system of any preceding or subsequent examples or combination of examples, wherein the first association indicates an Internet Protocol address of the first device and the second association indicates an address of the second device.

Example 9 is the system of any preceding or subsequent examples or combination of examples, wherein the first communication protocol comprises a as serial line Internet Protocol and the second communication protocol comprises a Recommended Standard-485 protocol.

Example 10 is a computer-implemented method for dual protocol communication of pool or spa equipment of a pool or spa system, the method comprising: determining that a first device of equipment of the pool or spa system is associated with a first communication protocol; communicating with the first device via the first communication protocol; determining that a second device of the equipment of the pool or spa system is associated with a second communication protocol; and communicating with the second device via the second communication protocol.

Example 11 is the computer-implemented method of any preceding or subsequent examples or combination of examples, wherein the first communication protocol comprises an Internet Protocol-based communication protocol and the second communication protocol comprises a non-Internet Protocol-based communication protocol, and wherein the method further comprises: coordinating communication with the first device using the Internet Protocol-based communication protocol and the second device using the non-Internet Protocol-based communication protocol to prevent receiving simultaneous messages from the first device and the second device.

Example 12 is the computer-implemented method of any preceding or subsequent examples or combination of examples, wherein the first communication protocol comprises an Internet Protocol-based communication protocol, and wherein determining that the first device is associated with a first communication protocol comprises: receiving, from the first device, a broadcast message indicating an Internet Protocol address of the first device; and determining, based on the broadcast message, that the first device is associated with the Internet Protocol-based communication protocol.

Example 13 is the computer-implemented method of any preceding or subsequent examples or combination of examples, wherein the second communication protocol comprises a non-Internet Protocol-based communication protocol, and wherein determining that the second device is associated with a second communication protocol comprises: receiving, from the second device, a message indicating an address of the second device; and determining, based on the message, that the second device is associated with the non-Internet Protocol-based communication protocol.

Example 14 is the computer-implemented method of any preceding or subsequent examples or combination of examples, wherein the first communication protocol comprises an Internet Protocol-based communication protocol and the second communication protocol comprises a non-Internet Protocol-based communication protocol, and wherein communicating with the first device via the first communication protocol and with the second device via the second communication protocol comprises: sending, using a bus, a first message to the first device using the Internet Protocol-based communication protocol; receiving, using the bus and from the first device, a first response to the first message using the Internet Protocol-based communication protocol; sending, using the bus, a second message to the second device using the non-Internet Protocol-based communication protocol; and receiving, using the bus and from the second device, a second response to the second message using the non-Internet Protocol-based communication protocol.

Example 15 is the computer-implemented method of any preceding or subsequent examples or combination of examples, further comprising: storing a first association between the first device and the first communication protocol; and storing a second association between the second device and the second communication protocol.

Example 16 is a pool automation controller for a pool or spa system configured for dual protocol communication of pool or spa equipment, the pool automation controller comprising: a memory configured to store computer-executable instructions; and one or more processors configured to access the memory and execute the computer-executable instructions to at least: determine that a first device of the plurality devices is associated with a first communication protocol; communicate, using a bus configured to communicate with the plurality of devices of the pool or spa equipment, with the first device via the first communication protocol; determine that the second device of the plurality of devices is associated with a second communication protocol; and communicate, using the bus, with the second device via the second communication protocol.

Example 17 is the pool automation controller of any preceding or subsequent examples or combination of examples, wherein at least one of the first communication protocol or the second communication protocol comprises an Internet Protocol-based communication protocol.

Example 18 is the pool automation controller of any preceding or subsequent examples or combination of examples, wherein at least one of the first communication protocol or the second communication protocol comprises a non-Internet Protocol-based communication protocol.

Example 19 is the pool automation controller of any preceding or subsequent examples or combination of examples, wherein the first communication protocol comprises an Internet Protocol-based communication protocol, and wherein determining that the first device is associated with a first communication protocol comprises: receiving, from the first device, a broadcast message indicating an Internet Protocol address of the first device; and determining, based on the broadcast message, that the first device is associated with the Internet Protocol-based communication protocol.

Example 20 is the pool automation controller of any preceding or subsequent examples or combination of examples, wherein the second communication protocol comprises a non-Internet Protocol-based communication protocol, and wherein determining that the second device is associated with a second communication protocol comprises: receiving, from the second device, a message indicating an address of the second device; and determining, based on the message, that the second device is associated with the non-Internet Protocol-based communication protocol.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computing systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

All references, including publications, patent applications, and patents, cited herein are hereby incorporated by reference to the same extent as if each reference were individually and specifically indicated to be incorporated by reference and were set forth in its entirety herein.

The examples described herein are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Finally, references to “pools” and “swimming pools” herein may also refer to spas or other water containing vessels used for recreation, training, or therapy.

What is claimed is:

1. A pool or spa system configured for dual protocol communication with pool or spa equipment, the system comprising:
a plurality of devices of equipment, the plurality of devices of the equipment including a first device and a second device;
a bus configured to communicate with a pool automation controller, the first device, and the second device; and
the pool automation controller comprising:
a memory configured to store computer-executable instructions; and
one or more processors configured to access the memory and execute the computer-executable instructions to at least:
determine that the first device is associated with a first communication protocol;
communicate, using the bus, with the first device via the first communication protocol;
determine that the second device is associated with a second communication protocol; and
communicate, using the bus, with the second device via the second communication protocol.

2. The system of claim 1, wherein at least one of the first communication protocol or the second communication protocol comprises an Internet Protocol-based communication protocol.

3. The system of claim 1, wherein at least one of the first communication protocol or the second communication protocol comprises a non-Internet Protocol-based communication protocol.

4. The system of claim 1, wherein the first communication protocol comprises an Internet Protocol-based communication protocol, and wherein determining that the first device is associated with a first communication protocol comprises:
receiving, from the first device, a broadcast message indicating an Internet Protocol address of the first device; and
determining, based on the broadcast message, that the first device is associated with the Internet Protocol-based communication protocol.

5. The system of claim 1, wherein the second communication protocol comprises a non-Internet Protocol-based communication protocol, and wherein determining that the second device is associated with a second communication protocol comprises:
receiving, from the second device, a message indicating an address of the second device; and
determining, based on the message, that the second device is associated with the non-Internet Protocol-based communication protocol.

6. The system of claim 1, wherein the first communication protocol comprises an Internet Protocol-based communication protocol and the second communication protocol comprises a non-Internet Protocol-based communication protocol, and wherein communicating, using the bus, with the first device via the first communication protocol and with the second device via the second communication protocol comprises:
sending, using the bus, a first message to the first device using the Internet Protocol-based communication protocol;
receiving, using the bus and from the first device, a first response to the first message using the Internet Protocol-based communication protocol;
sending, using the bus, a second message to the second device using the non-Internet Protocol-based communication protocol; and
receiving, using the bus and from the second device, a second response to the second message using the non-Internet Protocol-based communication protocol.

7. The system of claim 1, wherein the one or more processors are configured to access the memory and execute the computer-executable instructions to further at least:
store a first association between the first device and the first communication protocol; and
store a second association between the second device and the second communication protocol.

8. The system of claim 7, wherein the first association indicates an Internet Protocol address of the first device and the second association indicates an address of the second device.

9. The system of claim 1, wherein the first communication protocol comprises a serial line Internet Protocol and the second communication protocol comprises a Recommended Standard-485 protocol.

10. A computer-implemented method for dual protocol communication with pool or spa equipment of a pool or spa system, the method comprising:
determining that a first device of equipment of the pool or spa system is associated with a first communication protocol;
communicating with the first device via the first communication protocol;
determining that a second device of the equipment of the pool or spa system is associated with a second communication protocol; and
communicating with the second device via the second communication protocol.

11. The computer-implemented method of claim 10, wherein the first communication protocol comprises an Internet Protocol-based communication protocol and the second communication protocol comprises a non-Internet Protocol-based communication protocol, and wherein the method further comprises:
coordinating communication with the first device using the Internet Protocol-based communication protocol and the second device using the non-Internet Protocol-based communication protocol to prevent receiving simultaneous messages from the first device and the second device.

12. The computer-implemented method of claim 10, wherein the first communication protocol comprises an Internet Protocol-based communication protocol, and wherein determining that the first device is associated with a first communication protocol comprises:
receiving, from the first device, a broadcast message indicating an Internet Protocol address of the first device; and
determining, based on the broadcast message, that the first device is associated with the Internet Protocol-based communication protocol.

13. The computer-implemented method of claim 10, wherein the second communication protocol comprises a non-Internet Protocol-based communication protocol, and wherein determining that the second device is associated with a second communication protocol comprises:
receiving, from the second device, a message indicating an address of the second device; and
determining, based on the message, that the second device is associated with the non-Internet Protocol-based communication protocol.

14. The computer-implemented method of claim 10, wherein the first communication protocol comprises an Internet Protocol-based communication protocol and the second communication protocol comprises a non-Internet Protocol-based communication protocol, and wherein communicating with the first device via the first communication protocol and with the second device via the second communication protocol comprises:
sending, using a bus, a first message to the first device using the Internet Protocol-based communication protocol;
receiving, using the bus and from the first device, a first response to the first message using the Internet Protocol-based communication protocol;
sending, using the bus, a second message to the second device using the non-Internet Protocol-based communication protocol; and
receiving, using the bus and from the second device, a second response to the second message using the non-Internet Protocol-based communication protocol.

15. The computer-implemented method of claim 10, further comprising:
storing a first association between the first device and the first communication protocol; and
storing a second association between the second device and the second communication protocol.

16. A pool automation controller for a pool or spa system configured for dual protocol communication with pool or spa equipment, the pool automation controller comprising:
a memory configured to store computer-executable instructions; and
one or more processors configured to access the memory and execute the computer-executable instructions to at least:
determine that a first device of a plurality devices is associated with a first communication protocol;
communicate, using a bus configured to communicate with the plurality of devices of the pool or spa equipment, with the first device via the first communication protocol;
determine that the second device of the plurality of devices is associated with a second communication protocol; and
communicate, using the bus, with the second device via the second communication protocol.

17. The pool automation controller of claim 16, wherein at least one of the first communication protocol or the second communication protocol comprises an Internet Protocol-based communication protocol.

18. The pool automation controller of claim 16, wherein at least one of the first communication protocol or the second communication protocol comprises a non-Internet Protocol-based communication protocol.

19. The pool automation controller of claim 16, wherein the first communication protocol comprises an Internet Protocol-based communication protocol, and wherein determining that the first device is associated with a first communication protocol comprises:
receiving, from the first device, a broadcast message indicating an Internet Protocol address of the first device; and
determining, based on the broadcast message, that the first device is associated with the Internet Protocol-based communication protocol.

20. The pool automation controller of claim 16, wherein the second communication protocol comprises a non-Internet Protocol-based communication protocol, and wherein determining that the second device is associated with a second communication protocol comprises:
receiving, from the second device, a message indicating an address of the second device; and
determining, based on the message, that the second device is associated with the non-Internet Protocol-based communication protocol.
